(19) United States
(12) Patent Application Publication
(10) Pub. No.: US 2005/0196146 A1
(43) Pub. Date: Sep. 8, 2005

(54) Method for reproducing text subtitle and text subtitle decoding system

(76) Inventors: Jea Yong Yoo, Seoul (KR); Kang Soo Seo, Anyang-si (KR); Byung Jin Kim, Seongnam-si (KR)

Correspondence Address: HARNESS, DICKEY & PIERCE, P.L.C., P.O. BOX 8910, RESTON, VA, 20195, US

(21) Appl. No.: 10/957,572

(22) Filed: Oct. 5, 2004

Related U.S. Application Data
(60) Provisional application No. 60/542,852, filed on Feb. 10, 2004.
(60) Provisional application No. 60/542,850, filed on Feb. 10, 2004.
(60) Provisional application No. 60/543,328, filed on Feb. 11, 2004.

(30) Foreign Application Priority Data
Mar. 22, 2004 (KR) 10-2004-0019437

(51) Int. Cl. H04N 5/781

(52) U.S. Cl. 386/95; 386/126

(57) ABSTRACT

A method for reproducing text subtitle streams and a text subtitle decoding system are disclosed. An entire subtitle text subtitle file designated in a playlist file and font files related to the subtitle text subtitle file are initially preloaded into a subtitle preloading buffer and a font preloading buffer, respectively, before starting playback of the playlist file. Thereafter, the playlist file is played back in order to reproduce at least one audio/video (AV) stream file further designated in the playlist file and the preloaded text subtitle file simultaneously.

This application claims the benefit of Korean Patent Application No. 10-2004-019437, filed on Mar. 22, 2004, which is hereby incorporated by reference.

### BACKGROUND OF THE INVENTION

1. Field of the Invention

The present invention relates to an optical disc, and more particularly, to a method for reproducing text subtitle streams recorded in an optical disc and a text subtitle decoding system.

2. Discussion of the Related Art

Optical discs are widely used as an optical recording medium for recording mass data. Presently, among a wide range of optical discs, a new high density (HD) optical recording medium, such as a Blu-ray Disc (hereafter referred to as “BD”), is under development for writing and storing high definition video and audio data for a long period of time.

Currently, global standard technical specifications of the Blu-ray Disc (BD), which is known to be the next generation HD-DVD technology, are under establishment as a next generation optical recording solution that is able to have data significantly surpassing the conventional DVD, along with many other digital apparatuses. Accordingly, optical reproducing apparatuses having the Blu-ray Disc (BD) standards applied thereto are also being developed. However, since the Blu-ray Disc (BD) standards are yet to be completed, there have been many difficulties in developing a complete optical reproducing apparatus.

Most particularly, in order to effectively reproduce the data from the Blu-ray Disc (BD), not only information on a structural data file of the data recorded in the Blu-ray Disc (BD), but also information for effectively forming and managing the data file should be systemized and provided. However, in the present Blu-ray Disc (BD) standards, since the standards of the auxiliary data, particularly the subtitle information, are not completely consolidated, there are many restrictions in the full-scale development of a Blu-ray Disc (BD) basis optical reproducing apparatus. And, such restrictions cause problems in reproducing the data stream and providing the data stream to the user.

### SUMMARY OF THE INVENTION

Accordingly, the present invention is directed to a method for reproducing text subtitle streams and a text subtitle decoding system that substantially obviate one or more problems due to limitations and disadvantages of the related art.

An object of the present invention is to provide a method for reproducing text subtitle streams and a text subtitle decoder that guarantee seamless presentation of a text subtitle.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method of reproducing text subtitle streams recorded in an optical disc includes the steps of preloading an entire text subtitle file designated in a playlist file in a first buffer at once before starting palyback of the playlist file, and playing back the playlist file in order to reproduce at least one audio/video (AV) stream file designated in the playlist file and the preloaded text subtitle file simultaneously. The method may further include the step of preloading font files related with the text subtitle file in a second buffer before starting the playback of the playlist file.

In another aspect of the present invention, a method of reproducing text subtitle streams recorded in an optical disc includes the steps of preloading a plurality of text subtitle files, which are designated in a playlist file for multiple languages application, in a first buffer at once before staring playback of the playlist file, and playing back of the playlist file in order to reproduce at least one audio/video (AV) stream file further designated in the playlist file and one of the preloaded text subtitle files simultaneously. The method may further include the step of preloading font files related with the plurality of text subtitle stream files in a second buffer at once before starting the playback of the playlist file.

In another aspect of the present invention, a decoding system for decoding text subtitle streams recorded in an optical disc includes a subtitle preloading buffer and a text subtitle decoder. The subtitle preloading buffer is configured to preload an entire text subtitle file at once before at least one audio/video (AV) stream file is reproduced. The text subtitle file and the AV stream file are designated in a playlist file. The text subtitle decoder is configured to decode the text subtitle file preloaded in the subtitle preloading buffer. The decoding system may further include a font preloading buffer configured to preload font files related with the text subtitle file at once before the AV stream file is reproduced.

In another aspect of the present invention, a decoding system for decoding text subtitle streams recoded in an optical disc includes a subtitle preloading buffer and a text subtitle decoder. The subtitle preloading buffer is configured to preload a plurality of text subtitle files at once before at least one audio/video (AV) stream file designated in a playlist file is reproduced. The plurality of text subtitle files are also designated in the playlist file for multiple languages application. The text subtitle decoder is configured to decode one of the text subtitle files preloaded in the subtitle preloading buffer. The decoding system may further include a font preloading buffer configured to preload font files related with the plurality of text subtitle files at once before the AV stream file is reproduced.

In a further aspect of the present invention, a disc player for reproducing text subtitle streams recorded in an optical disc includes an audio decoding part decoding audio streams recorded in the disc, a video decoding part configured to decode video streams recorded in the disc, and a subtitle decoding part. The subtitle decoding part is configured to preload an entire text subtitle file at once before at least one audio/video (AV) stream file is reproduced, and to decode the preloaded text subtitle file. The text subtitle file and the AV stream file are designated in a playlist file. The subtitle decoding part may include a subtitle preloading buffer preloading the entire text subtitle file at once before the AV stream file is reproduced, and a text subtitle decoder decoding the text subtitle file preloaded in the subtitle preloading buffer. The subtitle decoding part may further include a font preloading buffer configured to preload font files related with the text subtitle file at once before the AV stream file is reproduced.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates the structure of the data files recorded in an optical disc according to the present invention;

FIG. 2 illustrates data storage areas of an optical disc;

FIG. 3 illustrates an example of reproduction control information;

FIGS. 4A and 4B illustrate examples of a text subtitle displayed on a display screen;

FIG. 5 illustrates an example a method of reproducing text subtitle streams according to the present invention;

FIGS. 6A to 6C illustrate various playback control information for one or more PlayList files;

FIG. 7 illustrates an apparatus of decoding AV streams and text subtitle streams according to the present invention; and

FIG. 8 illustrates the text subtitle decoder 42 shown in FIG. 7 in more details;

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

In this detailed description, main data represent audio/video (AV) data that belong to a title (e.g., a movie title) recorded in an optical disc by an author. In general, the AV data are recorded in MPEG2 format and are often called AV streams or main AV streams. In addition, supplementary data represent all other data required for reproducing the main data, examples of which are text subtitle streams, interactive graphic streams, presentation graphic streams, and supplementary audio streams (e.g., for browsable slideshow). These supplementary data streams may be recorded in MPEG2 format or any other data format. They could be multiplexed with the AV streams or exist as independent data files.

A subtitle represents caption information of images being reproduced and is often represented in a predetermined language. For example, when a user selects an option for viewing one of a plurality of subtitles supporting various languages while viewing images on a display screen, corresponding caption information is displayed on a predetermined portion of the display screen. When the displayed caption information is text data, the subtitle is called a text subtitle. According to the present invention, a plurality of text subtitle streams in MPEG2 format may be recorded in an optical disc and may exist as one or more independent stream files. Each text subtitle stream includes text data for a text subtitle and reproduction control data required for reproduction of the text data. Alternatively, only a single text subtitle stream in MPEG2 format may be recorded in the optical disc.

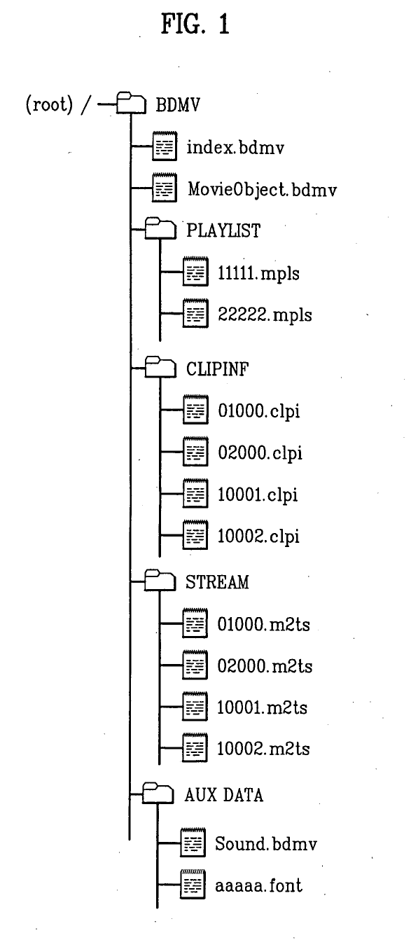

FIG. 1 illustrates the structure of the data files recorded in a blue-ray (BD) disc according to the present invention. Referring to FIG. 1, at least one BD directory (BDMV) is included in a root directory (root). Each BD directory includes an index file (index.bdmv) and an object file (MovieObject.bdmv), which are used for interacting with one or more users. For example, the index file may contain an index table which includes information regarding a plurality of selectable menus and movie titles. Each BD directory further includes four file directories that include AV data to be reproduced and various data required for reproduction of the AV data.

The file directories included in each BD directory are a stream directory (STREAM), a clip information directory (CLIPINF), a playlist directory (PLAYLIST), and an auxiliary data directory (AUX DATA). The stream directory includes video/audio (AV) stream files having a particular format. The AV streams may be in the form of MEPG2 transport packets and be named as “*.m2ts”, as shown in FIG. 1. The stream directory may further include one or more text subtitle stream files, where each text subtitle stream file includes text data for a text subtitle in a particular language and reproduction control information of the text data. The subtitle stream files may be multiplexed with the AV streams within the stream directory, or they could exist as independent stream files within the stream directory. In the latter case, such independent stream files may be named as “*.m2ts” or “*.txtst.” Alternatively, the text subtitle stream files may be included in the auxiliary data directory.

Next, the clip information directory (CLIPINF) includes clip information files (e.g., 01000.clpi and 02000.clpi shown in FIG. 1) that correspond to the stream files included in the stream directory, respectively. Each clip information file contains property and timing information of a corresponding stream file, where the timing information includes mapping information that maps Presentation Time Stamp (PTS) with Source Packet Number (SPN) using Entry Point Map. In the industry standard, each pair of a stream file and its corresponding clip information file is designated as a clip. For example, 01000.clpi included in CLIPINF includes property and timing information of 01000.m2ts included in STREAM, and 01000.clpi and 01000.m2ts form a clip.

Referring back to FIG. 1, the playlist directory (PLAYLIST) includes one or more PlayList files (*.mpls), where each PlayList file includes at least one PlayItem which designates at least one main AV clip and the reproduction time of the main AV clip. More specifically, a PlayItem includes information designating beginning and ending times (In-Time and Out-Time) for reproduction of a main AV clip, which may be designated by Clip_Information_File_Name within the PlayItem. Therefore, a PlayList file represents the basic reproduction control information for one or more main AV clips. In addition, the PlayList file may further include a SubPlayItem, which is the basic reproduction control information of supplemental data, such as a text subtitle stream file. When a SubPlayItem is included in the PlayList file to reproduce one or more text subtitle streams, the SubPlayItem is often synchronized with the PlayItem(s). On the other hand, when the SubPlayItem is used to reproduce a browsable slideshow, it may not be synchronized with the PlayItem(s). According to the present invention, the SubPlayItem controls reproduction of a text subtitle stream, which will be described later in more detail.

The auxiliary data directory (AUX DATA) may include supplementary data streams, example of which are font files (aaaaa.font shown in FIG. 1), pop-up menu files (not illustrated), and click-sound (Sound.bdmv) data files.

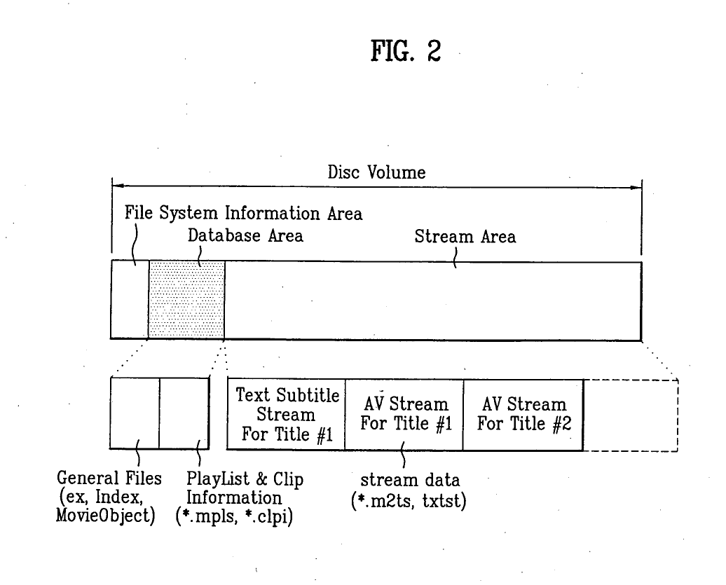

FIG. 2 illustrates data storage areas of an optical disc, in which the data files shown in FIG. 1 are recorded. As shown in the figure, the disc includes a file system information area occupying the inmost portion of the disc volume, a stream area occupying the outmost portion of the disc volume, and a database area occupied between the file system information area and the stream area. In the file system information area, system information for managing the entire data files is recorded. Next, AV streams and one or more text subtitle streams are prerecorded in the stream area. The general files, PlayList files, and clip information files are prerecorded in the database area of the disc volume. As discussed above, the general files include an index file and an object file, and the PlayList files and clip information files include information required to reproduce the AV streams and text subtitle streams recorded in the stream area. A user is able to select a specific play-back mode and to reproduce desired main and supplementary streams in the selected play-back mode using the information stored in the database area and/or stream area.

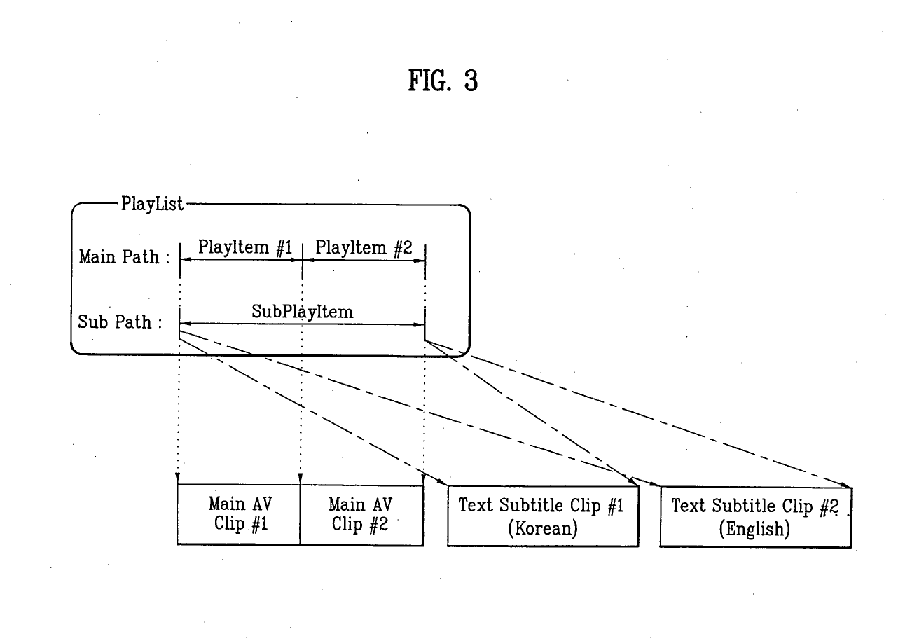

FIG. 3 illustrates an example of reproduction control information for reproducing main AV clips and text subtitle clips according to the present invention. The reproduction of a title having main AV clips and text subtitle clips may be controlled by at least one PlayList file. More specifically, the reproduction of one or more main AV clips for a title is controlled by at least one PlayItem included in each PlayList file. The reproduction of a main AV clip may be controlled by a single PlayItem, as shown in FIG. 3, or by more than one PlayItems. In addition, the reproduction of one or more text subtitle clips is controlled by a SubPlayItem included in each PlayList file. Although it is not illustrated in FIG. 3, the reproduction of an audio clip for a browsable slideshow and/or a clip containing interactive graphic streams may be controlled by an additional SubPlayItem, which may be further included in the PlayList file.

More than one independent text subtitle clips may exist to support various languages, and the reproduction of such text subtitle clips are controlled by a single SubPlayItem. The font files required when reproducing the text subtitle clips are designated in the clip information files of the text subtitle clips. According to the present invention, before a PlayList file is executed, one or more text subtitle stream files supporting a single subtitle language or multiple subtitle languages and the associated font files may be preloaded in buffers, respectively. More details to this will be described later.

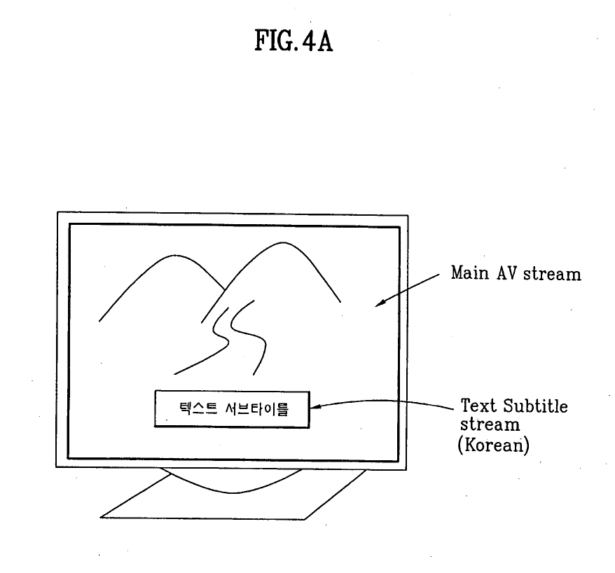

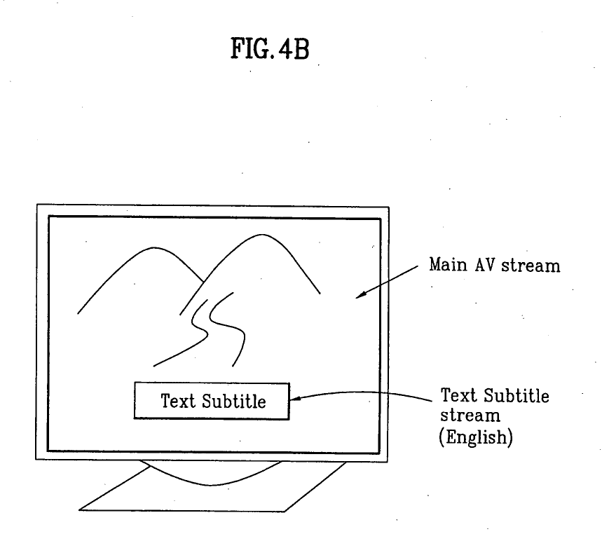

FIGS. 4A and 4B illustrate examples of a text subtitle displayed on a display screen. The texts of the subtitle shown in FIG. 4A are in Korean, and texts of the subtitle shown in FIG. 4B are in English. In order to support both languages, there are two independent text subtitle files recorded in an optical disc.

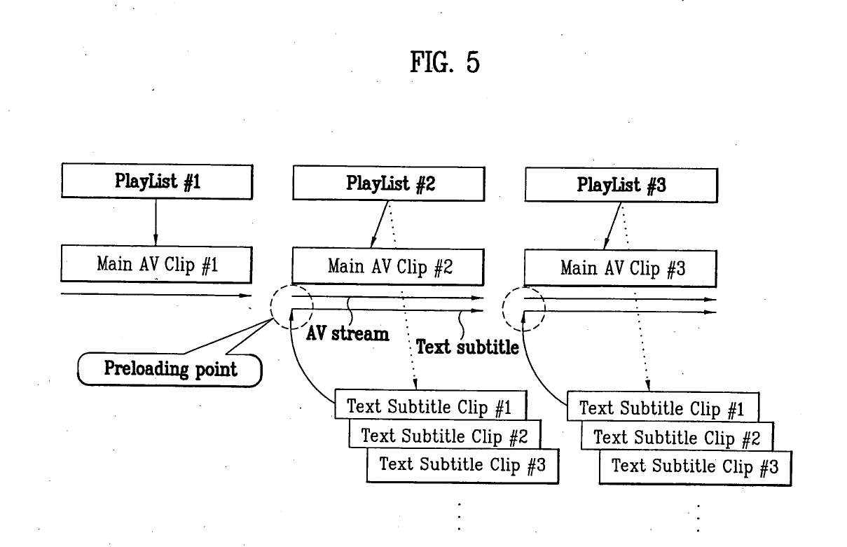

FIG. 5 illustrates an example of a method of reproducing one or more text subtitle stream files according to the present invention. As described above, a PlayList file controls reproduction of one or more main AV clips and a text subtitle clip, where each main AV clip includes a main AV stream file and a corresponding clip information file. The reproduction of the main AV clips is controlled by at least one PlayItem included in the PlayList file, and the reproduction of the text subtitle clip is controlled by a SubPlayItem included in the PlayList file. Each of the PlayItem and Sub-PlayItem includes information indicating the beginning and ending times for reproducing a corresponding clip.

In one aspect of the present invention, an entire text subtitle file designated in a PlayList file for single language application and related font files are preloaded at once into a first buffer and a second buffer, respectively, before starting playback of the PlayList file such that seamless presentation of a text subtitle is ensured. In other words, the entire text subtitle file and the related font files are preloaded into the buffers before at least one AV stream file further designated in the PlayList file is reproduced. After the text subtitle file is entirely preloaded into the buffer, the PlayList file is played back in order to start reproducing the AV stream designated in the PlayList file and the preloaded text subtitle file simultaneously.

In another aspect of the present invention, a plurality of text subtitle stream files and related font files are preloaded into the first and second buffers at once, respectively, before starting playback of a PlayList file, in which the text subtitle files are designated for multi-languages application, in order to ensure seamless presentation of a text subtitle when a user switches among various subtitle languages. In this case, the sizes of the first and second buffers should be large enough to store all the text subtitle stream files and all the related font files at once. If the text subtitle stream files and the font files are not preloaded at once into the buffers, such files should be read from the optical disc each time the user switches among the text subtitle streams, and this may not guarantee seamless presentation of a text subtitle.

In general, the size of each text subtitle file may be limited. For example, assuming a total of 2000 text subtitles for a movie, 2 lines of texts for each text subtitle, 30 characters for each line of texts, and 2 bytes for each character, the size of the text data required for a text subtitle in a single language is about 240 kilobytes. Further assuming that the style information for the text subtitle is about 240 kilobytes, a total size of the text subtitle stream file is about 480 kilobytes. Therefore, the size of each text subtitle file may be limited such that it is less than or equal to 0.5 megabytes.

For preloading a single text subtitle file at once, the size of the first buffer should be greater than or equal to a size of the subtitle file. For example, assuming that the size of the subtitle file is about 480 kilobytes, the size of the first buffer may be greater than or equal to 0.5 megabytes. On the other hand, for preloading a plurality of text subtitle files at once, the size of the first buffer should be greater than or equal to a combined size of the subtitle files. For example, assuming that the size of the each subtitle file is about 480 kilobytes and there are a total of 3 subtitle files (for Korean, English, and Japanese), the size of the first buffer should be greater than 1.5 megabytes.

Referring back to FIG. 5, one or more text subtitle stream files and the associated font files are preloaded into the first and second buffers, respectively, before a corresponding PlayList file is executed. For example, all the text subtitle stream files are preloaded into the first buffer before PlayList No. 2 is executed to reproduce main AV clip No. 2.

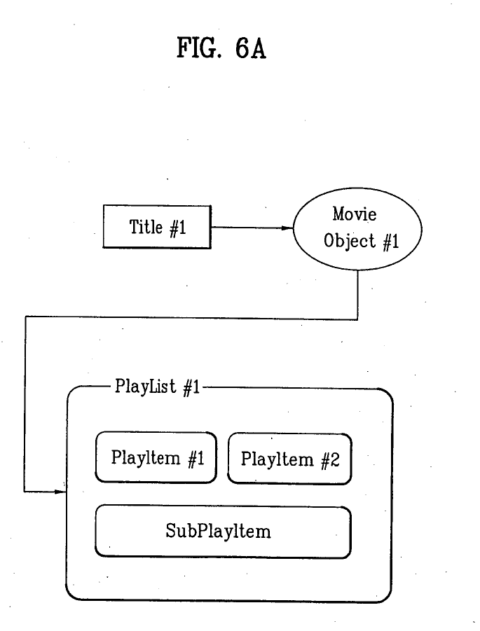

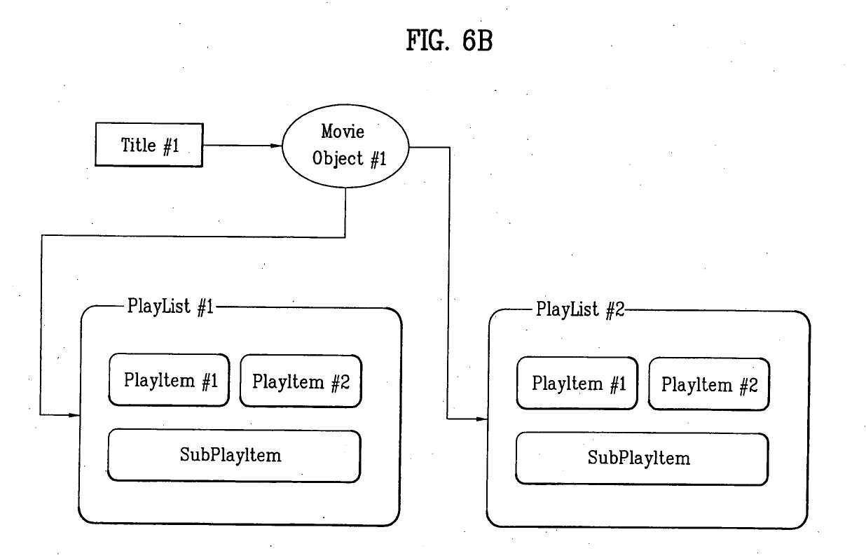

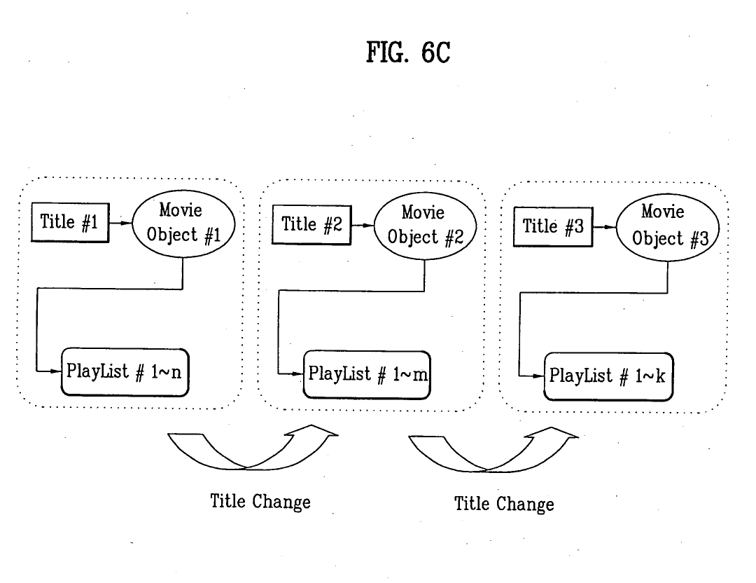

FIGS. 6A to 6C illustrate various playback control information for one or more PlayList file according to the present invention. A movie object represents a group of navigation commands for reproducing a title selected by a user. Referring to FIG. 6A, a movie object for a title controls reproduction of a PlayList file. The title may be selected by an index table (index.table) included in the index file (index.bdmv), which is for interacting with users. When the PlayList file is played back (executed), the main AV streams are reproduced by PlayItems, and the text subtitle streams and associated font information are reproduced by a SubPlayItem, as shown in FIG. 6A. According to the present invention, one or more text subtitle stream files and the related font files are preloaded at once before the PlayList file is played back to ensure seamless presentation of a text subtitle.

Next, referring to FIG. 6B, a movie object for a title controls reproduction of a plurality of PlayList files. For example, one or more text subtitle stream files and the associated font file that are controlled by the SubPlayItem of PlayList No. 1 are preloaded into the buffers in advance, and PlayList No. 1 is executed thereafter. During or after the execution of PlayList No. 1, one or more text subtitle stream files and the associated font files that are controlled by the SubPlayItem of PlayList No. 2 may be preloaded into the buffers in advance, and PlayList No. 2 may be executed thereafter.

Referring to FIG. 6C, a plurality of movie objects for a plurality of titles control reproduction of a plurality of PlayList file sets, respectively. When a user selects one of the plurality of titles, the movie object corresponding to the selected title controls reproduction of a corresponding set of PlayList files. Before each PlayList file is reproduced, one or more text subtitle stream files designated each PlayList file and related font file are preloaded into buffers. When a request for changing the title is made by the user through an index table, the movie object corresponding to a newly selected title controls reproduction of a corresponding set of PlayList files. Similarly, before each PlayList file is reproduced, one or more text subtitle stream files designated in each PlayList file and related font file are preloaded into the buffers.

As described above in detail, the features of the present invention are as follows. First, a SubPlayItem included in a PlayList file control reproduction of one or more text subtitle streams. Second, an entire text subtitle stream file or a plurality of text subtitle stream files designated in the PlayList file and related font file are preloaded into buffers to ensure seamless presentation of a text subtitle on a display screen.

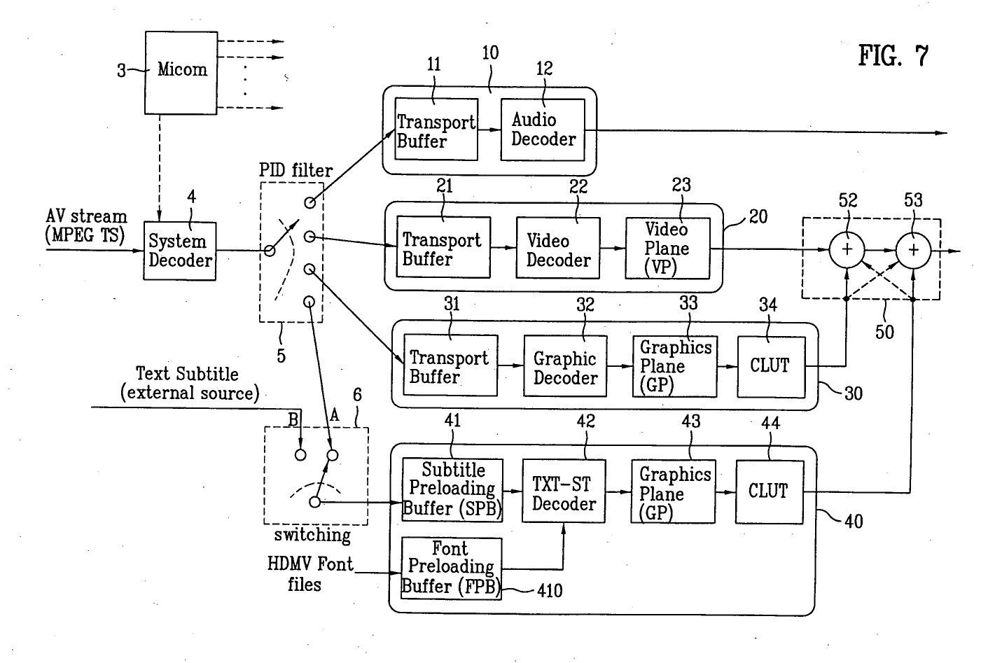

FIG. 7 illustrates an apparatus of decoding AV streams and text subtitle streams according to the present invention. The apparatus includes a packet identifier (PID) filter 5 for separating input streams into video streams, audio streams, graphic streams, and text subtitle streams based on their packet identifiers, a video decoding part 20 for reproducing the video streams, an audio decoding part 10 for reproducing the audio streams, a graphic decoding part 30 for reproducing the graphic streams, and a text subtitle decoding part 40 for reproducing the text subtitle streams.

The text subtitle streams may be extracted from an optical disc, or they could be inputted from an additional external source, as shown in FIG. 7. For this reason, the apparatus includes a switch 6 which selects an input data source. Therefore, if the text subtitle streams in MPEG format are extracted from the optical disc, the switch 6 selects data line A connected to the PID filter 5. On the other hand, if they are inputted through an additional external source, the switch 6 selects data line B which is connected to the external source.

The video decoding part 20, audio decoding part 10, graphic decoding part 30 include a transport buffer 21, 11, and 31, respectively, for storing a predetermined size of data streams to be decoded. A video plane 23 and a graphic plane 33 are included in the video decoding part 20 and graphic decoding part 30, respectively, for converting decoded signals into displayable images. The graphic decoding part 30 includes a color look up table (CLUT) 34 for controlling color and transparency levels of the displayable images.

When the text subtitle decoding part 40 receives one or more text subtitle streams from the switch 6, all of these streams are initially preloaded into a subtitle preloading buffer (SPB) 41 at once. Assuming a typical size of a text subtitle stream file for a single language is about 0.5 megabytes, the size of the subtitle preloading buffer 41 should be determined based on the total number of the text subtitle stream files. For example, in order to ensure seamless presentation of a text subtitle when a user switches among subtitle stream files supporting two languages, the size of the subtitle preloading buffer 41 should be greater than or equal to 1 megabytes. The size of the subtitle preloading buffer 41 should be large enough to preload all the required text subtitle stream files at once.

In addition, the text subtitle decoding part 40 further includes a font preloading buffer (FPB) 410 for storing all the associated font files which may be included in the auxiliary data directory shown in FIG. 1. The size of the font preloading buffer 410 may be in the range of 2 to 4 megabytes. In general, a size of about 4 megabytes is required for storing all the Chinese, Japanese, and Korean (CJK) font files, and a size of about 2 megabytes is usually large enough for supporting other non-CJK font files. Similarly, the size of the font preloading buffer 410 should be large enough to preload all the required font files at once in order to ensure seamless presentation of a text subtitle supporting one or more languages. Since all the text subtitle stream files and associated font files are preloaded, extraction and use of the preloaded data can be done in a very simple manner. Also, the control of the subtitle preloading buffer 41 and font preloading buffer 410 could be quite simple due to the same reason.

The text subtitle decoding part 40 further includes a text subtitle decoder 42 which decodes one or more text subtitle streams stored in the subtitle preloading buffer 41, a graphics plane 43 converting the decoded subtitle stream(s) into displayable images, and a color look up table (CLUT) 44 controlling the color and transparency levels of the converted images.

An image superimposition part 50 included in the apparatus shown in FIG. 7 combines the images outputted from the video decoding part 20, the graphic decoding part 30, and the text subtitle decoding part 40. These combined images are displayed on a display screen. The video images outputted from the video plane 23 of the video decoding part 20 are displayed as a background of the display screen, and the images outputted from the graphic decoding part 30 and/or the text subtitle decoding part 40 are superimposed over the displayed video images. For example, if the output images of the graphic decoding part 30 are interactive graphic images, the text subtitle images outputted from the text subtitle decoding part 40 are initially superimposed over the video images by a first adder 52. Thereafter, the interactive graphic images are further superimposed over the subtitle-superimposed images by a second adder 53.

The apparatus shown in FIG. 7 further includes a system decoder 4 for decoding input transport streams (e.g., MPEG transport streams), and a microprocessor 3 for controlling operations of all the mentioned components of the apparatus.

Reference will now be made in detail to a method of reproducing text subtitle streams according to the present invention. When an optical disc is preloaded by an optical disc player, an example of which is illustrated in FIG. 7, information required for reproduction of data recorded on the disc is initially extracted from the disc and stored in a memory (not illustrated). When a particular title that associates with a PlayList is selected by a user, at least one complete (entire) text subtitle stream file designated in the PlayList file is initially preloaded into the subtitle preloading buffer 41 and font files related to the subtitle stream file is preloaded into the font preloading buffer 410.

For example, when a title that associates with the PlayList shown in FIG. 3 is selected by a user, text subtitle files for text subtitle clip No. 1 (Korean) and text subtitle clip No. 2 (English) are initially preloaded into the subtitle preloading buffer 41. Also, font files related to the text subtitle files, which may be designated in clip information files of the text subtitle clips, are preloaded into the font preloading buffer 410. Thereafter, playback of the PlayList is started. During the playback of the PlayList, AV streams of main AV clips No. 1 and 2 are decoded by the audio decoding part 10 and the video decoding part 20, respectively, and selected one of the preloaded text subtitle streams is decoded by the text subtitle decoder 42. Then the decoded text subtitle images are superimposed over the decoded main video images, and the entire images are displayed on a display screen.

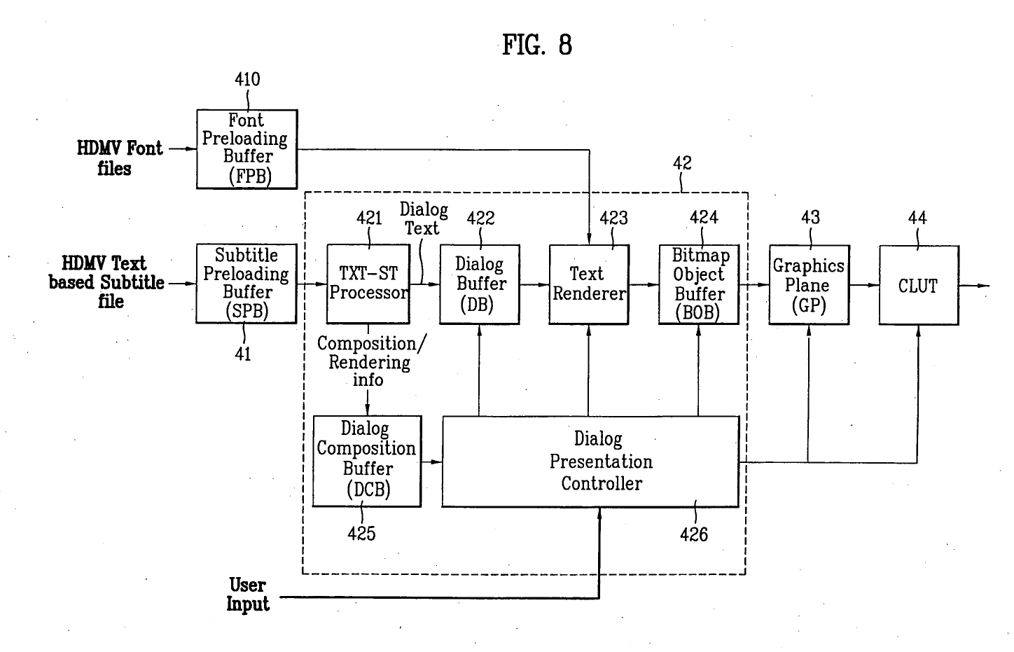

FIG. 8 illustrates the text subtitle decoder 42 shown in FIG. 7 in more details. The decoding process performed by the text subtitle decoder 42 includes parsing, rendering, and composition steps. In the parsing step, the text subtitle stream(s) stored in the subtitle preloading buffer (SPB) 41 is parsed into composition information, rendering information, and dialog text data. A dialog represents all the text subtitles that are displayed during a predetermined period of time, which may be defined by a presentation time stamp (PTS). In the rendering step, the parsed dialog text data are rendered into bitmap data using the rendering information, which represents style information required for rendering the dialog text data. Finally, in the composition step, the rendered text data are added into the graphics plane (GP) 43 according to the composition information, which represents information indicating time for displaying a text subtitle within the display screen.

Referring to FIG. 8, a text subtitle processor 421 included in the text subtitle decoder 42 parses the subtitle stream file(s) stored in the subtitle preloading buffer 41 into composition and rendering information and dialog text data. The composition and rendering information is then stored in a dialog composition buffer (DCB) 425, and the dialog text data are stored in a dialog buffer (DB) 422.

Next, a text renderer 423 renders the dialog text data stored in the dialog buffer 422 into bitmap data under control of a dialog presentation controller 426. In order to perform the rendering function, the text renderer 423 receives font data associated with the dialog text data from the font preloading buffer 410, receives rendering information and inline style information from the dialog presentation controller 426, and renders the dialog text data into bitmap data using the rendering information and inline style information, which is applicable for each text string of the dialog text data. Thereafter, the rendered text data are then stored in a bitmap object buffer (BOB) 424 as a bitmap object.

Finally, the bitmap object stored in the bitmap object buffer 424 is transferred (added) to the graphics plane 43 according to the composition information provided by the dialog presentation controller 426. The color look up table 44 uses palette information included in the composition information to adjust color and transparency levels of an output of the graphics plane 43.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. A method of reproducing text subtitle streams recorded in an optical disc, the method comprising:
preloading an entire text subtitle file designated in a playlist file in a first buffer at once before starting playback of the playlist file; and
playing back the playlist file in order to reproduce at least one audio/video (AV) stream file designated in the playlist file and the preloaded text subtitle file simultaneously.

2. The method of claim 1, further comprising:
preloading font files related with the text subtitle file in a second buffer before starting the playback of the playlist file.

3. The method of claim 2, wherein information designating the font files is included in a clip information file corresponding to the text subtitle file.

4. The method of claim 2, wherein a size of the second buffer is in the range of 2 to 4 megabytes.

5. The method of claim 2, wherein a size of the second buffer is 4 megabytes when the font files includes at least one of Chinese, Japanese, and Korean (CJK) font files.

6. The method of claim 1, wherein the text subtitle file is recorded in the optical disc and exists as an independent stream file.

7. The method of claim 1, wherein a size of the first buffer is greater than or equal to a size of the text subtitle file.

8. The method of claim 1, wherein a size of the first buffer is greater than or equal to 0.5 megabytes.

9. The method of claim 1, wherein the text subtitle file is designated in a subplayitem included in the playlist file, and the at least one AV stream file is designated in at least one playitem included in the playlist file.

10. A method of reproducing text subtitle streams recorded in an optical disc, the method comprising:
preloading a plurality of text subtitle files in a first buffer at once before starting playback of a playlist file, the plurality of text subtitle files being designated in the playlist for multiple languages application;
playing back the playlist file in order to reproduce at least one audio/video (AV) stream file designated in the playlist file and one of the preloaded text subtitle files simultaneously.

11. The method of claim 10, further comprising:
preloading font files related with the plurality of text subtitle stream files in a second buffer at once before starting the playback of the playlist file.

12. The method of claim 11, wherein a size of the second buffer is greater than or equal to a combined size of the font files.

13. The method of claim 10, wherein a size of the first buffer is greater than or equal to a combined size of the plurality of text subtitle files.

14. A method of reproducing text subtitle streams recorded in an optical disc, the method comprising:
preloading an entire text subtitle file designated in a subplayitem in a first buffer at once before starting playback of a playlist file, the subplayitem being included in the playlist file; and
playing back the playlist file in order to reproduce at least one audio/video (AV) stream file designated in at least one playitem and the preloaded text subtitle file simultaneously, the at least one playitem being included in the playlist file.

15. The method of claim 14, further comprising:
preloading font files related with the text subtitle file in a second buffer before starting the playback of the playlist file.

16. A system for decoding text subtitle streams recorded in an optical disc, the decoding system comprising:
a subtitle preloading buffer configured to preload an entire text subtitle file at once before at least one audio/video (AV) stream file is reproduced, the text subtitle file and the at least one AV stream file being designated in a playlist file; and
a text subtitle decoder configured to decode the text subtitle file preloaded in the subtitle preloading buffer.

17. The decoding system of claim 16, further comprising:
a font preloading buffer configured to preload font files related with the text subtitle file at once before the at least one AV stream file is reproduced.

18. The decoding system of claim 17, wherein information designating the font files is included in a clip information file corresponding to the text subtitle file.

19. The decoding system of claim 17, wherein a size of the font preloading buffer is in the range of 2 to 4 megabytes.

20. The decoding system of claim 16, wherein the text subtitle file is recorded in the optical disc and exist as an independent stream file.

21. The decoding system of claim 16, wherein a size of the subtitle preloading buffer is greater than or equal to a combined size of the text subtitle file.

22. The decoding system of claim 16, wherein the text subtitle file is designated in a subplayitem included in the playlist file, and the at least one AV stream file is designated in at least one playitem included in the playlist file.

23. The decoding system of claim 16, further comprising:
a graphics plane configured to convert an output of the text subtitle decoder into displayable images; and
a color look up table configured to control colors and transparency levels of the displayable images.

24. The decoding system of claim 16, wherein the text subtitle decoder comprises:
a text subtitle processor configured to parse the preloaded text subtitle file into composition and rendering information and dialog text data;
a dialog composition buffer configured to store the composition and rendering information;
a dialog buffer configured to store the dialog text data;
a text renderer configured to render the dialog text data stored in the dialog buffer into a bitmap object according to the composition and rendering information stored in the dialog composition buffer; and
a bitmap object buffer storing the bitmap object.

25. A decoding system for decoding text subtitle streams recorded in an optical disc, the decoding system comprising:
a subtitle preloading buffer configured to preload a plurality of text subtitles files at once before at least one audio/video (AV) stream file designated in a playlist file is reproduced, the plurality of text subtitle files being designated in the playlist file for multiple languages application; and
a text subtitle decoder configured to decode one of the text subtitle files preloaded in the subtitle preloading buffer.

26. The decoding system of claim 25, further comprising:
a font preloading buffer configured to preload font files related with the plurality of text subtitle files at once before the at least one AV stream file is reproduced.

27. The decoding system of claim 26, wherein a size of the font preloading buffer is greater than or equal to a combined size of the font files.

28. The decoding system of claim 26, wherein the text subtitle decoder decodes one of the preloaded text subtitles files using the font files preloaded in the font preloading buffer.

29. The decoding system of claim 25, wherein a size of the subtitle preloading buffer is greater than or equal to a combined size of the plurality of text subtitle files.

30. A disc player for reproducing text subtitle streams recorded in an optical disc, the disc player comprising:
an audio decoding part configured to decode audio streams recorded in the disc;
a video decoding part configured to decode video streams recorded in the disc; and
a subtitle decoding part configured to preload an entire text subtitle file at once before at least one audio/video (AV) stream file is reproduced, and to decode the preloaded text subtitle file, the text subtitle file and the at least one AV stream file being designated in a playlist file.

31. The disc player of claim 30, wherein the subtitle decoding part comprises:
a subtitle preloading buffer configured to preload the entire text subtitle file at once before the at least one AV stream file is reproduced; and
a text subtitle decoder configured to decode the text subtitle file preloaded in the subtitle preloading buffer.

32. The disc player of claim 31, wherein the subtitle decoding part further comprises:
a font preloading buffer configured to preload font files related with the text subtitle file at once before the at least one AV stream file is reproduced.
